(19) United States
(12) Patent Application Publication
(10) Pub. No.: US 2015/0372303 A1
(43) Pub. Date: Dec. 24, 2015

(54) Method for Making Lithium Transition Metal Olivines Using Water/Cosolvent Mixtures

(71) Applicant: DOW GLOBAL TECHNOLOGIES LLC, Midland, MI (US)

(72) Inventors: Yu-Hua Kao, Midland, MI (US); Stacie L. Santhany, Auburn, MI (US); Murali G. Theivanayagam, Midland, MI (US); Xindi Yu, Midland, MI (US); Lingbo Zhu, Midland, MI (US); Ing-Feng Hu, Midland, MI (US); Michael M. Oken, Midland, MI (US); Robin P. Ziebarth, Midland, MI (US)

(21) Appl. No.: 14/646,683

(22) PCT Filed: Mar. 4, 2013
(86) PCT No.: PCT/US2013/028834

§ 371 Date: May 21, 2015

Related U.S. Application Data
(60) Provisional application No. 61/740,593, filed on Dec. 21, 2012.

(51) Int. Cl. H01M 4/58; H01M 10/0568; H01M 10/0525; C01B 25/45

(52) U.S. Cl. CPC H01M 4/5825; C01B 25/45; H01M 10/0568; H01M 10/0525; C01P 2004/51; C01P 2004/62; C01P 2004/61; H01M 2220/20; H01M 2220/30

(57) ABSTRACT

Olivine lithium manganese iron phosphate is made in a coprecipitation process from a water/alcoholic cosolvent mixture. The LMFP particles so obtained exhibit surprisingly high electronic conductivities, which in turn leads to other advantages such as high energy and power densities and excellent cycling performance.

The present invention relates to a method for making lithium transition metal olivines and lithium battery electrode materials containing lithium transition metal olivines.

Lithium batteries are widely used as primary and secondary batteries for vehicles and many types of electronic equipment. These batteries often have high energy and power densities.

Lithium transition metal compounds are commonly used as cathode materials in these batteries. Among the lithium transition metal compounds that have been described as cathode materials are rock salt-structured compounds such as LiCoO₂, spinels such as LiMn₂O₄, and olivine materials such as lithium iron phosphates, lithium cobalt iron phosphates and lithium manganese iron phosphates. For example, LiFePO₄ is known as a low cost material that is thermally stable and has low toxicity and high rate capability (high power density). However, LiFePO₄ has a relatively low working voltage (3.4V vs. Li+/Li) and because of this has a low energy density.

In principle, the working voltage and therefore the energy density can be increased by substituting manganese for some or all of the iron, because manganese has a higher working voltage. Electrode materials of this type are known as “lithium manganese iron phosphate” or “LMFP” materials. In practice, however, these electrode materials have not performed satisfactorily.

One reason is the density of olivine LMFP electrode materials is lower than that of lithium iron phosphate cathode materials. This means that a smaller mass of LMFP materials can be packed into a given volume which in turn means that some or all of this theoretical improvement in energy density is lost because the mass of LMFP per unit volume in the electrode is lower.

Replacing the iron with manganese also has been found to cause very significant problems with transportation kinetics, i.e., the rate at which lithium can move in and out of the electrode material during charging and discharging. The effect of this is that power densities fall far short of theoretical levels. Although batteries containing these electrodes of exhibit reasonably good specific capacities when operated at low C rates, their performance suffers considerably when discharged at high C rates. Compared to LiFePO₄ electrodes, the LMFP electrodes have performed unexpectedly poorly at high discharge rates.

To compensate for its poorer electronic and ion conduction, olivine LMFP materials need to have smaller particles sizes (to decrease the length of conduction pathways through the material) and to be compounded with relatively high amounts of carbon (to improve electronic conductivity), compared with lithium iron phosphates. Each of these requirements adds to the difficulty in obtaining high densities of the material in an electrode. In addition, the need to produce very small particles adds complexity and expense to the synthesis process.

As a result of these problems, the potential increase in energy density obtained by substituting manganese for iron is canceled out by the lower density of LMFP cathode materials, the difficulty in obtaining good packing and the need to compound them with rather high amounts of carbon.

Another major shortcoming of LMFP electrode materials is their cycling stability. LiFePO₄ electrodes tend to be highly stable, and batteries containing these electrodes retain their specific capacities well over a large number of charge/discharge cycles. LMFP electrode materials have not to date exhibited comparable cycling stability.

As shown, for example, in WO 2011/0258323, this problem becomes increasingly worse as more and more of the iron is replaced by manganese. Although energy densities and power densities theoretically should increase as more iron is replaced by manganese, in fact the reverse tends to happen, especially when 50% or more of the iron is replaced with manganese.

Because of these problems, the potential benefits of LMFP electrodes have not been realized. It would be desirable to provide LMFP electrode materials that exhibit better power and energy densities and better cycling performance.

WO 2007/113624 describes a process for making a lithium transition metal olivine using acetate salts as the sources for the lithium and the transition metal. This process uses ammonium dihydrogen phosphate as the source of phosphate ions. Additional acetic acid is also present. This process produces ammonium acetate and acetic acid as reaction by-products, which remain with the reaction mixture as it undergoes a refluxing step to form crystals of the lithium transition metal olivine. These reaction by-products must be removed from the reaction solvents in order to re-use the solvents, or else the solvents must be disposed of. In either case, the process requires many processing steps and associated costs, and often does not provide a lithium transition metal olivine material that has a high enough energy density. No cell performance information is provided in WO 2007/113624.

In WO 2008/077448, LMFP is produced by precipitation from dilute solutions of precursors in a mixture of water and dimethylsulfoxide. The process is said to produce small LMFP particles with a narrow particle size distribution. The formation of small LMFP uniformly sized particles is hypothesized as a remedy for the slow ion transport through the material, as the ions would need to travel smaller distances through the LMFP material. However, WO 2008/077448 provides no cell performance information.

This invention is in one aspect a coprecipitation method for making olivine lithium iron manganese phosphate particles, comprising the steps of:

a) forming a solution of a water-soluble iron precursor, a water-soluble manganese precursor, phosphoric acid and optionally a water-soluble dopant metal precursor in a mixture of water and an alcoholic cosolvent, wherein:

a-1) the mole ratio of iron to manganese in the solution is from 0.1:0.9 to 0.9:0.1;

a-2) the dopant metal, if present at all, is present in an amount of up to 3 mole-%, based on the total moles of iron, manganese and the dopant metal; and

a-3) the mole ratio of iron, manganese and dopant metal combined to phosphoric acid is 0.75:1 to 1.25:1;

b) at a temperature of at least 80° C., adding a solution of lithium hydroxide in water or a mixture of water and the alcoholic cosolvent to the solution formed in step a) in an amount such that:

b-1) the mole ratio of lithium to phosphate ions is from 2.5 to 3.5:1;

b-2) after addition of the lithium hydroxide solution, the mixture contains 0.1 to 0.8 moles of phosphate ions per liter of water/cosolvent mixture; and

b-3) the weight ratio of water and cosolvent after the addition of the lithium hydroxide solution is from 20:80 to 75:25, provided that the weight ratio of water and cosolvent after addition of the lithium hydroxide solution is from 20:80 to 60:40 when the mixture contains 0.2 moles or less of phosphate ions per liter of water/cosolvent mixture; and

c) heating the resulting solution to a temperature of at least 100° C. up to the boiling temperature of the solution to form the olivine lithium manganese iron phosphate (LMFP).

This process provides an olivine LMFP electrode material having excellent electrochemical properties. The LMFP formed in the process often exhibits particularly high specific capacities, even at high charge/discharge rates.

It has been found that the cosolvent concentration and the concentration of the LMFP precursor materials can have important effects on the electrochemical properties of the LMFP material formed in the process. In general, when the concentration of LMFP precursor materials in toward the low end of the foregoing range, better results are obtained at somewhat higher cosolvent concentrations (within the foregoing range). When greater concentrations of LMFP materials are present (within the foregoing ranges) somewhat lower cosolvent concentrations (once again within the foregoing range) tend to provide the best results.

A very surprising result is that an LMFP having excellent electrochemical properties can be obtained in some cases, even when the LMFP particles form agglomerates having particle sizes of up to 5000 nm and have a wide size range. The particle size of the LMFP primary particles obtained in the process tends to be quite small, typically in the range of 50 to 300 nm.

Another surprising advantage of this invention is that even though agglomerates form in some cases, the primary particle are electronically conductive enough that very little carbon coating is needed to provide adequate electron conductivity. Because less carbon coating is needed, the amount of LMFP that can be packed into a given volume can be increased correspondingly, which in turn leads to higher energy and power densities. The good electronic conductivity of the carbon-coated primary particles also allows one to use a smaller amount of a conductive carbon additive (˜2 wt %) during the electrode assembly process, again increasing the LMFP concentration and providing better performances.

In step a) of the process of this invention, a solution of a water-soluble iron precursor, a water-soluble manganese precursor, phosphoric acid and optionally a water-soluble dopant metal precursor is formed in a mixture of water and a cosolvent. The order of addition during step a) is in general not critical. In some embodiments, the precursor materials (iron sulfate, manganese sulfate, dopant metal precursor if any and phosphoric acid) are dissolved in water, and the alcoholic cosolvent is added to the resulting solution. In a particular method, the water-soluble iron precursor, water-soluble manganese precursor, and water-soluble dopant metal precursor are dissolved all at once or sequentially in any order into an aqueous phosphoric acid solution, followed by addition of the alcoholic cosolvent.

The proportions of starting materials in step a) are such that

a-1) the mole ratio of iron to manganese in the solution is from 0.1:0.9 to 0.9:0.1;

a-2) the dopant metal, if present at all, is present in an amount of up to 3 mole-%, based on the total moles of iron, manganese and the dopant metal;

a-3) the mole ratio of iron, manganese and dopant metal combined to phosphoric acid is 0.75:1 to 1.25:1.

The mole ratio of iron to manganese in some embodiments is from 0.1:0.9 to 0.5:0.5. In other embodiments, the ratio of iron to manganese is from 0.15:0.85 to 0.35:0.65.

The amount of dopant metal, if present, preferably is 1 to 3 mole-% based on the total moles of iron, manganese and dopant metal. In some embodiments, no dopant metal is present.

The water-soluble iron precursor may be, for example, iron (II) sulfate, iron (II) nitrate, iron (II) phosphate, iron (II) hydrogen phosphate, iron (II) dihydrogen phosphate, iron (II) carbonate, iron (II) hydrogen carbonate, iron (II) formate, iron (II) acetate.

The water-soluble manganese precursor may be, for example, manganese (II) sulfate, manganese (II) nitrate, manganese (II) phosphate, manganese (II) hydrogen phosphate, manganese (II) dihydrogen phosphate, manganese (II) carbonate, manganese (II) hydrogen carbonate, manganese (II) formate and manganese (II) acetate.

The preferred iron and manganese precursors are iron (II) sulfate and manganese (II) sulfate, respectively.

The dopant metal, if present, is selected from one or more of magnesium, calcium, strontium, cobalt, titanium, zirconium, molybdenum, vanadium, niobium, nickel, scandium, chromium, copper, zinc, beryllium, lanthanum and aluminum. The dopant metal is preferably magnesium or a mixture of magnesium and with or more of calcium, strontium, cobalt, titanium, zirconium, molybdenum, vanadium, niobium, nickel, scandium, chromium, copper, zinc, beryllium, lanthanum and aluminum. The dopant metal is most preferably magnesium or cobalt or a mixture thereof. The dopant metal precursor is a water-soluble salt of the dopant metal including, for example, a phosphate, hydrogen phosphate, dihydrogen phosphate, carbonate, formate, acetate, glycolate, lactate, tartrate, oxalate, oxide, hydroxide, fluoride, chloride, nitrate, sulfate, bromide and like salts of the dopant metal.

The mole ratio of iron, manganese and dopant metal combined to phosphoric acid may be 0.9 to 1.1:1, 0.95 to 1.05:1, or 0.95 to 1.02:1.

The solution formed in step a) may contain water and cosolvent at a weight ratio of 20:80 to 80:20. It is generally advantageous to add all of the cosolvent into the solution formed in step a), before step b) is performed, and for that reason the amount of cosolvent in the solution formed in step a) may be somewhat higher than is present after the lithium hydroxide solution is added in step b). In some embodiments, the weight ratio of water to cosolvent in the solution formed in step a) may be, for example, 20:80 to 80:20 or from 20:80 to 75:25. In some embodiments this weight ratio may be 70:30 to 40:60. In other embodiments, the weight ratio of water to cosolvent in the solution formed in step a) may be 50:50 to 35:65. These weight ratios take into account waters of hydration of the iron, manganese and dopant metal precursors.

The cosolvent is an alcohol which contains one or more hydroxyl groups, preferably at least two hydroxyl groups and especially exactly two hydroxyl groups. The cosolvent should be soluble in water at the relative proportions present, should be liquid at room temperature and should have a boiling temperature in excess of 100° C. It preferably has a molecular weight up to 1000, preferably up to 250. Examples of suitable cosolvents include ethylene glycol, diethylene glycol, triethylene glycol, tetraethylene glycol, propylene glycol, dipropylene glycol, tripropylene glycol, tetrapropylene glycol, 1,4-butane diol, other polyalkylene glycols having a molecular weight up to about 1000, glycerin, trimethylolpropane, trimethylolethane, 2-methoxyethanol, 2-ethoxyethanol and the like. Diethylene glycol is a preferred cosolvent. Two or more cosolvents can be present.

Step a) can be performed at any temperature at which the water/cosolvent mixture is a liquid. A convenient temperature is 0 to 100° C. and a more preferred temperature is 10 to 80° C. or even 20 to 80° C. In some embodiments, the precursor materials are dissolved in water at a temperature of 10 to 50° C., especially 20 to 40° C., and the cosolvent is added to the resulting solution.

In the solution formed in step a), some or all of the phosphoric acid may become partially neutralized by the iron, manganese and/or dopant metals to form soluble iron, manganese and/or dopant metal phosphate compounds. The step a) solution is generally strongly acidic, generally having a pH of 2.5 or less.

Step b) is performed at a temperature of at least 80° C. and more preferably at a temperature of at least 95° C. Accordingly, the temperature of the solution formed in step a) is brought to this temperature if necessary before performing step b). The temperature during step b) may be as high as the boiling temperature of the water/cosolvent mixture. Step b) can be performed at atmospheric, subatmospheric or superatmospheric pressure.

In step b), a solution of lithium hydroxide in water or a mixture of water and the cosolvent is added to the solution formed in step a). The amount of lithium hydroxide solution and the concentration lithium hydroxide in the solution preferably are selected such that the mole ratio of lithium to phosphate ions is 2.5 to 3.5:1 after the lithium hydroxide solution and the solution formed in step a) are combined. The number of moles of “phosphate ions” is taken as equal to the number of moles of phosphoric acid provided in step a). The term “phosphate ions” is used herein to include all PO₄-containing ions formed by the dissociation and/or neutralization of phosphoric acid during steps a) and b), including phosphate (PO₄⁻³), hydrogen phosphate (HPO₄⁻²) and dihydrogen phosphate (H₂PO₄⁻¹) ions, and including ions in the precipitate that forms when the lithium hydroxide and step a) solutions are combined. The mole ratio of lithium to phosphate ions, after step b) is performed, in some embodiments is 2.8 to 3.2:1, or 2.9 to 3.1:1 or 2:96 to 3.1:1.

The weight ratio of water and cosolvent after the addition of the lithium hydroxide solution to the solution made in step a) is from 20:80 to 75:25, and the concentration of phosphate ions is 0.1 to 0.8 moles per liter of solution. It has been found that especially good results are obtained when (1) the concentration of cosolvent is near the higher end of the stated range and the concentration of phosphate ions is near the lower end of the stated range or (2) the concentration of cosolvent is near the lower end of the stated range and the concentration of phosphate ions is near the higher end of the stated range given the LiOH addition temperature is above 80° C. Thus, in some embodiments, the weight ratio of water to cosolvent may be 55:45 to 20:80 and the concentration of phosphate ions is 0.1 to 0.25 moles phosphate/liter of water/cosolvent mixture. In other embodiments, the weight ratio of water to cosolvent may be 70:30 to 55:45 and the concentration of phosphate ions is 0.25 to 0.6 moles, especially 0.35 to 0.5 moles phosphate/liter of water/cosolvent mixture.

Step b) preferably is performed by adding the lithium hydroxide solution rapidly to the step a) solution under agitation. The lithium hydroxide addition preferably is performed over a period of not more than 1 minute, preferably not more than 30 seconds and still more preferably not more than 15 seconds. It is believed to be important that the pH increase that occurs upon adding the strongly basic lithium hydroxide solution to the step a) solution takes place rapidly. Slower addition of the lithium hydroxide can lead to the formation of thermodynamically stable non-olivine crystalline phases as impurities.

Precipitates form upon combining the lithium hydroxide and step a) solutions. These precipitates include various iron, manganese and/or dopant metal phosphate compounds which may have an olivine crystalline structure but are believed to include a significant amount of compounds that do not have the olivine crystalline structure.

After step b) is completed, the resulting slurry is heated to at least 100° C. to form olivine LMFP particles. The temperature during this step may be as high as the boiling temperature of the cosolvent/water mixture. The heating step may be continued for several minutes to several hours. The mixture preferably is agitated during the heating step to keep the precipitate from settling before the desired olivine material is obtained. Formation of olivine LMFP during this heating step can be monitored by X-ray crystallographic methods.

The product of the process is an olivine LMFP material in the form of fine particles, which typically consist of primary particles and agglomerates of primary particles. The process tends to form very fine primary particles (which may be at least partially agglomerated), especially when, as described before, (1) the concentration of cosolvent is near the higher end of the stated range and the concentration of phosphate ions is near the lower end of the stated range or (2) the concentration of cosolvent is near the lower end of the stated range and the concentration of phosphate ions is near the higher end of the stated range.

Particle size (including that of agglomerates) and particle size distribution for purposes of this invention are the d50 particle size and the ratio (d90-d10)/d50 as measured by a light scattering particle size analyzer. The d50 particle size may be from 50 nm to 5000 nm, especially 100 nm to 3000 nm and in some cases from 100 nm to 300 nm or 100 nm to 200 nm. The particle size distribution (d90-d10)/d50 is, for example, 0.75 to 2.5, preferably 0.9 to 2.25 and more preferably 0.95 to 1.75. A surprising effect of the invention is that good results are often seen even when a somewhat wide particle size distribution is obtained.

The size of the primary particles (i.e., that of non-agglomerated particles and of the individual particles contained in the agglomerates is determined by inspecting scanning electron microscopy images, which allow primary particles to be distinguished from agglomerates. The size of the primary particles may be, for example, from 50 nm to 500 nm, especially from 50 to 300 nm or in some embodiments 100 to 200 nm. In general, smaller primary particles (such as 50 to 500 nm, especially 50 to 300 nm or 100 to 200 nm) tend to correlate to better electrochemical properties. Nonetheless, in some cases very good electrochemical performance is seen even when significant agglomeration of the primary particles has occurred, so that the measured particle size by light scattering methods is as much as 5000 nm.

The LMFP is a lithium manganese iron phosphate, optionally doped with dopant metal ions. The LMFP material in some embodiments has the empirical formula (as determined from the quantities of starting materials) LiₐMn_{b}Fe_{c}D_{d}PO₄, wherein D is the dopant metal;

a is a number from 0.5 to 1.5 preferably 0.8 to 1.2 and more preferably 0.9 to 1.1 and still more preferably 0.96 to 1.1;

b is from 0.1 to 0.9, preferably from 0.65 to 0.85;

c is from 0.1 to 0.9, preferably from 0.15 to 0.35;

d is from 0.00 to 0.03, in some embodiments 0.01 to 0.03;

b+c+d=0.75 to 1.25, preferably 0.9 to 1.1, more preferably 0.95 to 1.05 and still more preferably 0.95 to 1.02; and

a+2(b+c+d) is 2.75 to 3.15, preferably 2.85 to 3.10 and more preferably 2.95 to 3.15.

At the conclusion of the process, the olivine lithium manganese iron phosphate particles can be separated from the cosolvent using any convenient liquid-solid separation method such as filtration, centrifugation, and the like. The separated solids may be dried to remove residual water and cosolvent. This drying can be performed at elevated temperature (such as from 50 to 250° C.) and is preferably performed under subatmospheric pressure. The solids may be washed one or more times if desired with the cosolvent, water, a water/cosolvent mixture or other solvent for the cosolvent, prior to the drying step.

The olivine LMFP produced in the process is useful as an electrode material, particularly as a cathode material, in various types of lithium batteries. It can be formulated into electrodes in any convenient manner, typically by blending it with a binder, forming a slurry and casting it onto a current collector. The electrode may contain particles and/or fibers of an electroconductive material such as graphite, carbon black, carbon fibers, carbon nanotubes, metals and the like. The olivine LMFP particles may be formed into a nanocomposite with graphite, carbon black and/or other conductive carbon using, for example, ball milling processes as described in WO 2009/127901, or by combining the particles with a compound such as sucrose or glucose and calcining the mixture at a temperature sufficient to pyrolyze the compound.

Therefore, in preferred aspects, the LMFP of the invention is formed into a nanocomposite with a conductive carbon. In general, such a nanocomposite may contain 70 to 99% by weight of the olivine LMFP particles, preferably 75 to 99% by weight thereof, and up to 1 to 30%, more preferably 1 to 25% by weight of carbon. However, a surprising advantage of this invention is that the LMFP produced in this process is electronically conductive enough that very little carbon is needed to provide adequate electron conductivity. Thus, in especially preferred embodiments, a nanocomposite is formed with 94 to 99%, even more preferably 96 to 99% and especially 97 to 99% by weight of the LMPF material and from 1 to 6%, even more preferably 1 to 4% and especially 1 to 3% by weight of conductive carbon. These amounts of carbon are often insufficient to cover the entire exposed surfaces of the LMFP particles (as measured by BET methods), but, very surprisingly, very high electron conductivities are nonetheless seen. Such nanocomposites often exhibit high powder tap densities as well as high electrode densities.

The olivine LMFP phosphate produced in the process of this invention often exhibits a surprisingly high specific capacity over a range of discharge rates. Specific capacity is measured using half-cells at 25° C. on electrochemical testing using a Maccor 4000 electrochemical tester or equivalent electrochemical tester, using in order discharge rates of C/10, 1C, 5C, 10C and finally 0.1C. The lithium transition metal olivine produced in accordance with the invention in some embodiments exhibits a specific capacity of at least 130 mAh/g on the first C/10 discharge rate and at least 100 mAh/g on the 1C discharge rate. In some embodiments, the specific capacity is at least 135 mAh/g or at least 140 mAh/g on the first C/10 discharge rate and at least 130 mAh/g on the 1C discharge rate.

A lithium battery containing such a cathode can have any suitable design. Such a battery typically comprises, in addition to the cathode, an anode, a separator disposed between the anode and cathode, and an electrolyte solution in contact with the anode and cathode. The electrolyte solution includes a solvent and a lithium salt.

Suitable anode materials include, for example, carbonaceous materials such as natural or artificial graphite, carbonized pitch, carbon fibers, graphitized mesophase microspheres, furnace black, acetylene black, and various other graphitized materials. Suitable carbonaceous anodes and methods for constructing same are described, for example, in U.S. Pat. No. 7,169,511. Other suitable anode materials include lithium metal, lithium alloys, other lithium compounds such as lithium titanate and metal oxides such as TiO₂, SnO₂ and SiO₂.

The separator is conveniently a non-conductive material. It should not be reactive with or soluble in the electrolyte solution or any of the components of the electrolyte solution under operating conditions. Polymeric separators are generally suitable. Examples of suitable polymers for forming the separator include polyethylene, polypropylene, polybutene-1, poly-3-methylpentene, ethylene-propylene copolymers, polytetrafluoroethylene, polystyrene, polymethylmethacrylate, polydimethylsiloxane, polyethersulfones and the like.

The battery electrolyte solution has a lithium salt concentration of at least 0.1 moles/liter (0.1 M), preferably at least 0.5 moles/liter (0.5 M), more preferably at least 0.75 moles/liter (0.75 M), preferably up to 3 moles/liter (3.0 M), and more preferably up to 1.5 moles/liter (1.5 M). The lithium salt may be any that is suitable for battery use, including lithium salts such as LiAsFG, LiPF₆, LiPF₄(C₂O₄), LiPF₂(C₂O₄)₂, LiBF₄, LiB(C₂O₄)₂, LiBF₂(C₂O₄), LiClO₄, LiBrO₄, LiIO₄, LiB(C₆H₅)₄, LiCH₃SO₃, LiN(SO₂C₂F₅)₂, and LiCF₃SO₃. The solvent in the battery electrolyte solution may be or include, for example, a cyclic alkylene carbonate like ethyl carbonate; a dialkyl carbonate such as diethyl cabonate, dimethyl carbonate or methylethyl carbonate, various alkyl ethers; various cyclic esters; various mononitriles; dinitriles such as glutaronitrile; symmetric or asymmetric sulfones, as well as derivatives thereof; various sulfolanes, various organic esters and ether esters having up to 12 carbon atom, and the like.

The battery is preferably a secondary (rechargeable) battery, more preferably a secondary lithium battery. In such a battery, the discharge reaction includes a dissolution or delithiation of lithium ions from the anode into the electrolyte solution and concurrent incorporation of lithium ions into the cathode. The charging reaction, conversely, includes an incorporation of lithium ions into the anode from the electrolyte solution. Upon charging, lithium ions are reduced on the anode side. At the same time, lithium ions in the cathode material dissolve into the electrolyte solution.

The battery containing a cathode which includes olivine LMFP particles made in accordance with the invention can be used in industrial applications such as electric vehicles, hybrid electric vehicles, plug-in hybrid electric vehicles, aerospace vehicles and equipment, e-bikes, etc. The battery of the invention is also useful for operating a large number of electrical and electronic devices, such as computers, cameras, video cameras, cell phones, PDAs, MP3 and other music players, tools, televisions, toys, video game players, household appliances, medical devices such as pacemakers and defibrillators, among many others.

The following examples are provided to illustrate the invention, but are not intended to limit the scope thereof. All parts and percentages are by weight unless otherwise indicated.

### EXAMPLES 1-8 AND COMPARATIVE SAMPLES A AND B

Examples 1-8 and Comparative Samples A and B are made according to the following general procedure. Concentrated phosphoric acid is diluted with deoxygenated water. MnSO₄.H₂O and FeSO₄.7H₂O are sequentially dissolved in the phosphoric acid solution at 25° C. The mole ratio of manganese to iron is 0.76:0.24, and the mole ratio of manganese and iron combined to phosphate is 1:1. Diethylene glycol is then added to the resulting precursor solution in amounts as indicated in Table 1 below. The resulting solution is heated to 95° C. and an aqueous solution of lithium hydroxide is added rapidly with stirring. The mole ratio of lithium to phosphate is 3:1. The concentration of phosphate in each case is as given in Table 1. A precipitate forms immediately upon adding the lithium hydroxide solution. The resulting slurry is heated to reflux (101° C. to 110° C., depending on the diethylene glycol concentration) for five hours under a nitrogen atmosphere, with constant agitation. After the heating step is completed, the slurry is cooled, and the solids are washed and centrifuged to remove cosolvent and by-products.

The wet cake is re-suspended into deaerated water. A solution of glucose and sucrose is added, and the slurry is spray-dried in a nitrogen atmosphere, and the dried solids are calcined at 700° C. for 2 hours. The product so formed contains 2% by weight carbon.

Electrodes are made by mixing 93 parts by weight of the carbon-coated LMFP particles, 1 part carbon fibers, 1 part SUPER P conductive carbon black and 5 parts of polyvinylidene fluoride, and forming the mixture into an electrode. Half-cell electrochemical testing is performed on a Maccor electrochemical tester at 25° C. Specific capacities are as described in Table 1.

TABLE 1

| | Phosphate | | | | |
|---|---|---|---|---|---|
| | Concentration | | Specific Capacity | | |
| | moles/liter | | (C/10/ | | |
| Sample | water/cosolvent | Cosolvent | 1C/5C/10C/C/10) | d50 | (d90 − |
| Designation | mixture | Wt. % | mAh/g, | (nm) | d10)/d50 |
| A | 0.1 | 30 | 26/20/13/4/34 | 458 | 1.80 |
| 1 | 0.1 | 50 | 131/112/78/44/123 | 155 | 1.03 |
| 2 | 0.25 | 50 | 141/132/119/108/137 | 119 | 1.04 |
| 3 | 0.4 | 30 | 131/121/107/97/128 | 126 | 1.23 |
| 4 | 0.4 | 45 | 146/138/128/117/142 | 111 | 1.10 |
| 5 | 0.45 | 35 | 140/131/118/106/130 | 3264 | 2.18 |
| 6 | 0.5 | 30 | 137/127/109/94/132 | 248 | 1.75 |
| 7 | 0.55 | 25 | 119/102/74/56/121 | 13620 | 2.36 |
| 8 | 0.6 | 30 | 130/120/106/94/130 | 331 | 1.21 |
| B | 0.6 | 20 | Not tested | Large | Large |

Comparative Sample A illustrates the effect of using both a low concentration of cosolvent and of precursor materials. Somewhat large primary particles are formed which have a wide particle size distribution. Specific capacities are very low at all discharge rates. When the cosolvent concentration is increased to 50% (Example 1), the particle size drops, the particle size distribution is tighter and electrochemical performance is several times greater. Even better results are obtained when the concentration of precursors is increased to 0.25 moles/liter water/cosolvent mixture, when the cosolvent concentration is high (Example 2).

When the concentration of precursors is higher, as in Examples 3-8, very good results are obtained at lower cosolvent concentrations. Examples 4 and 5 show particularly good results. Example 5 is especially notable in that specific capacities are very high despite the presence of large agglomerates and the wide particle size distribution. Example 7 and Comparative Sample B together indicate that the lower limit on cosolvent concentration is about 25 weight percent; the performance of Example 7 is not as good as the other Examples, and the particle size and particle size distribution are very large. When the cosolvent concentration is decreased to 20%, as in Comparative Sample B, very large particles are obtain that have poor electrochemical performance.

1. A coprecipitation method for making olivine lithium iron manganese phosphate particles, comprising the steps of:
a) forming a solution of a water-soluble iron precursor, a water-soluble manganese precursor, phosphoric acid and optionally a water-soluble dopant metal precursor in a mixture of water and an alcoholic cosolvent, wherein:
a-1) the mole ratio of iron to manganese in the solution is from 0.1:0.9 to 0.9:0.1;
a-2) the dopant metal is present in an amount of up to 3 mole-%, based on the total moles of iron, manganese and the dopant metal; and
a-3) the mole ratio of iron, manganese and dopant metal combined to phosphoric acid is 0.75:1 to 1.25:1;
b) at a temperature of at least 80° C., adding a solution of lithium hydroxide in water or a mixture of water and the alcoholic cosolvent to the solution formed in step a in an amount such that:
b-1) the mole ratio of lithium to phosphate ions is from 2.5 to 3.5:1;
b-2) after addition of the lithium hydroxide solution, the mixture contains 0.1 to 0.8 moles of phosphate ions per liter of water/cosolvent mixture; and
b-3) the weight ratio of water and cosolvent after the addition of the lithium hydroxide solution is from 20:80 to 75:25, provided that the weight ratio of water and cosolvent after addition of the lithium hydroxide solution is from 20:80 to 60:40 when the mixture contains 0.2 moles or less of phosphate ions per liter of water/cosolvent mixture; and
c) heating the resulting solution to a temperature of at least 100° C. up to the boiling temperature of the solution to form the olivine lithium manganese iron phosphate.

2. The process of claim 1 wherein the cosolvent is one or more of ethylene glycol, diethylene glycol, triethylene glycol, tetraethylene glycol, propylene glycol, dipropylene glycol, tripropylene glycol, tetrapropylene glycol, 1,4-butane diol, a polyalkylene glycol having a molecular weight up to about 1000, glycerin, trimethylolpropane, trimethylolethane, 2-methoxyethanol and 2-ethoxyethanol.

3. The process of claim 2 wherein the cosolvent is diethylene glycol.

4. The process of claim 2 wherein the olivine lithium manganese iron phosphate has a measured d50 particle size from 500 nm to 5000 nm, and a particle size distribution (d90-d10)/d50 of 0.75 to 2.5.

5. The process of claim 2 wherein the olivine lithium manganese iron phosphate has a primary particle size of 50 to 300 nm.

6. The process of claim 2 wherein the mole ratio of iron to manganese is from 0.15:0.85 to 0.35:0.65.

7. The process of claim 2 wherein the mole ratio of iron, manganese and dopant metal combined to phosphoric acid is 0.95 to 1.02:1.

8. The process of claim 2 wherein the weight ratio of water to cosolvent is 55:45 to 20:80 and the concentration of phosphate ions is 0.1 to 0.25 moles phosphate ions/liter of water/cosolvent mixture.

9. The process of claim 2 wherein the weight ratio of water to cosolvent is 70:30 to 55:45 and the concentration of phosphate ions is 0.35 to 0.5 moles phosphate ions/liter of water/cosolvent mixture.

10. The process of claim 2, wherein the olivine lithium manganese iron phosphate LMFP material has the empirical formula LiₐMn_{b}Fe_{c}D_{d}PO₄, wherein D is the dopant metal;
a is a number from 0.5 to 1.5;
b is from 0.1 to 0.9;
c is from 0.1 to 0.9;
d is from 0.00 to 0.03;
b+c+d=0.75 to 1.25; and
a+2(b+c+d) is 2.75 to 3.15.

11. The process of claim 2, wherein the olivine lithium manganese iron phosphate LMFP material has the empirical formula LiₐMn_{b}Fe_{c}D_{d}PO₄, wherein D is the dopant metal;
a is a number from 0.96 to 1.1;
b is from 0.65 to 0.85;
c is from 0.15 to 0.35;
d is from 0.00 to 0.03;
b+c+d=0.95 to 1.02; and
a+2(b+c+d) is 2.95 to 3.15.

12. The process of claim 2, further comprising forming the olivine lithium manganese iron phosphate into a nanocomposite with conductive carbon.

13. The process of claim 12, wherein the nanocomposite contains 94 to 99% by weight of the olivine lithium manganese iron phosphate and 1 to 6% by weight of conductive carbon.

14. The process of claim 12, wherein the nanocomposite contains 97 to 99% by weight of the olivine lithium manganese iron phosphate and 1 to 3% by weight of conductive carbon.

15. The process of claim 2, wherein the water-soluble iron precursor is iron(II) sulfate and the water-soluble manganese precursor is manganese(II) sulfate.

16. A battery cathode comprising the product of the process of claim 1.

17. A lithium battery comprising an anode, a battery cathode of claim 16, a separator disposed between the anode and cathode, and an electrolyte solution containing at least one lithium salt.
